(19) United States
(12) Patent Application Publication
(10) Pub. No.: US 2026/0308413 A1
(43) Pub. Date: Oct. 8, 2026

(54) Reduced Carbon Footprint Painting Process for Waterborne Paint and Composition

(71) Applicant: Toyota Motor Engineering & Manufacturing North America, Inc., Plano, TX (US)

(72) Inventor: Cynthia G. TEMPLEMAN, Canton, MI (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 19/169,048

(22) Filed: Apr. 3, 2025

(51) Int. Cl. C09D 179/04; B05D 3/00; B05D 3/02; B05D 3/10; C09D 7/40; C09D 7/61

(52) U.S. Cl. CPC C09D 179/04; B05D 3/002; B05D 3/0218; B05D 3/0254; B05D 3/108; C09D 7/61; C09D 7/70

(57) ABSTRACT

Disclosed are compositions and methods for forming a multilayer coating including a waterborne basecoat composition, which comprises a film-forming resin comprising hydroxyl functional groups; a crosslinking-agent; at least one multifunctional isocyanate comprising between 4-6 isocyanate functional groups; and an aqueous solvent. The waterborne basecoat composition does not require preheating when employed in a multilayer coating process.

### TECHNICAL FIELD

The present disclosure generally relates to a multilayer coating process and waterborne coating compositions having a reduced carbon footprint.

### BACKGROUND

The background description provided herein is for the purpose of generally presenting the context of the disclosure.

Solvent-borne paints and primers have historically been used in vehicle assembly due to their low bake temperature, which helps reduce carbon emissions. However, despite this advantage, they are also known to be toxic and environmentally harmful, driving the need for safer alternatives. Waterborne basecoat compositions have not been used in low-bake technology processes; however, they have gained interest in the automotive industry as a more environmentally friendly alternative. Waterborne basecoat compositions typically have fewer volatile organic compounds (VOCs) than solvent-based paints and are friendly to automotive workers and the environment. As a result, waterborne painting technology has gained interest as a more environmentally friendly alternative to solvent-based basecoat compositions. However, one of the biggest challenges in implementing waterborne systems is the need to dehydrate or dry the basecoat (and some primers) before applying a clearcoat. This process typically relies on heated flash drying, requiring flash-off ovens to be preheated to approximately 80° C. for an extended period in addition to baking, i.e., curing, time. The paint booths and ovens required during this process are among the largest energy consumers in vehicle manufacturing placing a substantial strain on energy consumption and natural resources. Some production plants have turned away from such wasteful strains on the environment and cost-drivers in vehicle painting practices. There is a need for more efficient, cost-effective processes to reduce such a substantial energy demand and conserve resources while still maintaining the benefits of waterborne paints and primers.

### SUMMARY

This section provides a general summary of the disclosure and is not a comprehensive disclosure of its full scope or all of its features.

In various aspects, the present teachings provide a waterborne basecoat composition, comprising a film-forming resin comprising hydroxyl functional groups; a crosslinking-agent; at least one multifunctional isocyanate comprising between 4-6 isocyanate functional groups; and an aqueous solvent. The waterborne basecoat composition does not require preheating or flash-off with heat when employed in a multilayer coating process. In some examples the crosslinking agent is selected from melamine and melamine-formaldehyde resins. In some examples, the at least one multifunctional isocyanate comprises 4 isocyanate functional groups and in other examples the at least one multifunctional isocyanate comprises 6 isocyanate functional groups. The waterborne basecoat composition of the present disclosure may also comprise at least one pigment selected from organic pigments, inorganic pigments, metallic pigments, pearlescent pigments, carbon black, and anti-corrosive pigments. In some examples the at least one pigment is a metallic pigment, and in other examples, the metallic pigment comprises aluminum flakes. The waterborne basecoat composition of the present disclosure may also optionally include additives selected from solvents, dispersing agents, rheology modifiers, wetting agents, defoamers, pH adjusters, and stabilizers. In some aspects, the waterborne basecoat composition is employed to form a paint film. In other aspects the waterborne basecoat composition is employed to at least partially coat a substrate.

The present teachings also provide a method for forming a multilayer coating on a substrate which comprises forming an uncured basecoat film by applying a waterborne basecoat composition on the substrate; forming an uncured clearcoat film by applying a clearcoat composition on the uncured basecoat film; and simultaneously baking and curing the uncured basecoat film and the uncured clearcoat film. Depending on the clearcoat and thickness of the layers, baking may be at a temperature range of 50-160° C. The method does not include pre-heating the uncured basecoat film prior to forming the uncured clearcoat film. In some examples, the method of the present disclosure further involves, after applying the waterborne basecoat composition and prior to applying the clearcoat composition, allowing a room temperature flash-off time period for at least 5-10 minutes. In some examples, the method of the present disclosure further comprises, prior to applying the waterborne basecoat composition on the substrate, applying a primer composition on the substrate followed by baking to form a primer layer. The substrate may be selected from metal, plastic, composite materials, glass, ceramics, foams, and textiles. In some examples, amount of the waterborne basecoat compositions applied is 2-4 times less than the amount applied in a typical multilayer coating process to achieve a waterborne basecoat layer having a thickness of 10-20 micron layer. In some examples, the multilayer coating is a paint.

The waterborne basecoat composition employed in the method of the present disclosure comprises a film-forming resin comprising hydroxyl functional groups, a crosslinking agent, at least one multifunctional isocyanate comprising at between 4-6 isocyanate functional groups, and an aqueous solvent, and the waterborne basecoat composition does not require preheating or flash-off with heating before the clearcoat can be applied. In some examples the crosslinking agent is selected from melamine and melamine-formaldehyde resins. In some examples, the at least one multifunctional isocyanate comprises 4 isocyanate functional groups and in other examples the at least one multifunctional isocyanate comprises 6 isocyanate functional groups. The waterborne basecoat composition is employed to provide a 2-component coating wherein the multifunctional isocyanate is a separate component mixed with the other components of the waterborne basecoat composition prior to application on the substrate, typically by spraying.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings wherein:

FIGS. 1A, 1B, 1C, and 1D are illustrations of conventional multilayer coating processes of the present disclosure, where pre-heating or flash-off with heat after application of the waterborne coating composition and before application of the clearcoat composition is eliminated.

FIG. 2 illustrates the reaction scheme of isocyanate reactions using the waterborne basecoat composition in the multilayer coating process of the present disclosure.

FIG. 3 is a flowchart diagram illustrating an exemplary method of forming a multilayer coating on a substrate.

FIG. 4 is a flowchart diagram illustrating another exemplary method of forming a multilayer coating on a substrate.

It should be noted that the figures set forth herein are intended to exemplify the general characteristics of the methods, algorithms, and devices among those of the present technology, for the purpose of the description of certain aspects. These figures may not precisely reflect the characteristics of any given aspect and are not necessarily intended to define or limit specific embodiments within the scope of this technology. Further, certain aspects may incorporate features from a combination of figures.

### DETAILED DESCRIPTION

The present disclosure relates to a multilayer coating process utilizing a waterborne basecoat composition with a formulation designed to enable the reduction of traditional processing steps. In conventional coating processes, multiple bake cycles, including pre-heating or pre-bake, flash-off, and baking, are often required to achieve adequate curing and adhesion of the basecoat, resulting in increased energy consumption and production time. Traditionally, multilayer coating processes, such as low-bake, also referred to as low-temperature, coating processes involve several distinct stages, including surface preparation, basecoat application, intermediate baking or preheating to remove residual water, clearcoat application, and final baking. These intermediate baking or pre-heating steps, often referred to as “flash-off” or pre-drying stages are typically in the range of 80° C. to 120° C. for about 10 minutes, depending on the specific formulation, and are necessary to ensure that water is adequately removed from the basecoat before applying the subsequent clearcoat. Failure to do so can result in poor adhesion, surface defects, and compromised durability.

The present disclosure provides a novel paint process using a waterborne basecoat that does not require preheating as is typically required in a low bake automative paint process. The process of the present disclosure, by contrast to conventional multilayer coating processes, allows for the application and curing of the basecoat at low temperature and in fewer steps, without flash-off with heat or pre-drying steps prior to application of the clearcoat on the waterborne basecoat (WB), and without compromising coating performance. Conventional multilayer coating processes include flash-off with heat or pre-heating steps after application of the waterborne (WB) basecoat composition and prior to application of the clearcoat composition, requiring pre-heating of an oven designated for this drying step. In a typical process, a primer is applied to a substrate to form a primer coat layer followed by baking. A waterborne basecoat composition is applied on the primer coat layer followed by pre-heating or flash-off with heat to drive off water from the waterborne basecoat layer. A clearcoat composition may be applied on the waterborne basecoat followed by baking to simultaneously cure both the waterborne basecoat and the clearcoat.

The method of the present disclosure for forming a multilayer coating on a substrate comprises: forming an uncured basecoat film by applying a waterborne basecoat composition on the substrate; forming an uncured clearcoat film by applying a clearcoat composition on the uncured basecoat film without flash-off with heat or pre-drying the waterborne basecoat; and simultaneously baking and curing the uncured basecoat film and the uncured clearcoat film. The temperature at which baking to simultaneously cure the uncured basecoat film and the uncured clearcoat film occurs depends on the clearcoat and the substrate, e.g., the body of an automobile or a bumper, and may range from about 50° C.-160° C., 80° C.-130° C. or 110° C.-130° C. or 130-150° C. for about 10 to 60 minutes. In some examples of the present disclosure, the substrate may be metal, plastic, composite materials, glass ceramics, textiles and combinations thereof. The substrate may be pretreated prior to application of the waterborne basecoat composition. Such pretreatment may include applying a primer composition, which may be a solvent borne primer composition that is baked or a waterborne composition that is dehydrated, or it may be E-coated (i.e., electrodeposition coating) on the substrate followed by baking to form a primer layer. In cases where a vehicle is being re-coated, the substrate could be the previous layer's clearcoat. The basecoat may also be applied to some “high viscosity” or “indirect” materials such as body sealers, roof ditch sealers, anti-chip materials (e.g., PVC or urethane-based), and the like.

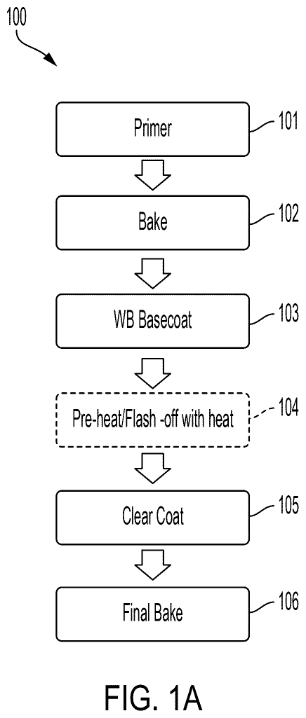

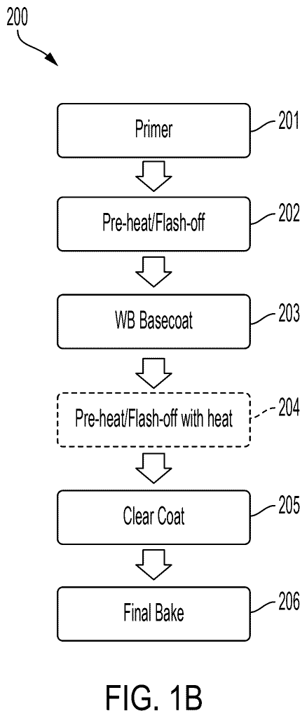

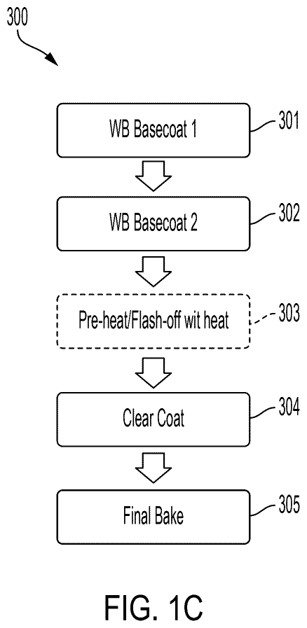

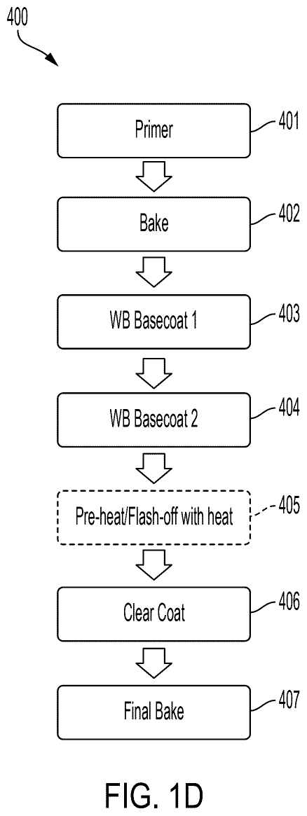

FIGS. 1A, 1B, 1C and 1D illustrate examples of multilayer coating processes according to the present disclosure. As compared to conventional multilayer coating processes, FIG. 1A illustrates an example of the multilayer coating process 100 of the present disclosure beginning with application of a primer to a substrate to form a primer coat layer at process block 101 followed by baking at process block 102. The process may also involve pre-treatment steps prior to application of the primer at process block 101. A waterborne basecoat composition is applied on the primer coat layer at process block 103. The conventional step at process block 104 of pre-heating or flash-off with heat to drive off water from the waterborne basecoat layer is omitted in the method of the present disclosure. A clearcoat composition may be applied on the waterborne basecoat at process block 105 followed by baking at process block 106 to simultaneously cure both the waterborne basecoat and the clearcoat. FIG. 1B, is an example of a variation of the multilayer coating process of the present disclosure beginning with application of a primer to a substrate to form a primer coat layer at process block 201 followed by pre-heating or flash-off with heat at process block 202. Following the pre-heating or flash-off with heat step a waterborne basecoat composition is applied on the primer coat layer at process block 203. The conventional step at process block 204 of pre-heating or flash-off with heat to drive off water from the waterborne basecoat layer is omitted in the method of the present disclosure. A clearcoat composition may be applied on the waterborne basecoat at process block 205 followed by baking at process block 206 to simultaneously cure both the waterborne basecoat and the clearcoat. FIG. 1C is another example of a variation of the multilayer coating process of the present disclosure beginning with application of a first waterborne basecoat composition to the substrate at process block 301 to form a first uncured waterborne basecoat layer, followed by application of a second waterborne basecoat composition at process block 302 on the first waterborne basecoat composition to form a second uncured waterborne basecoat layer. The conventional step at process block 303 of pre-heating or flash-off with heat to drive off water from the waterborne basecoat layer is omitted in the method of the present disclosure. A clearcoat composition may be applied on the waterborne basecoat at process block 304 followed by baking at process block 305 to simultaneously cure the waterborne basecoat layers and the clearcoat layer. It will be appreciated that the method of the present disclosure can be applied to other variations of multilayer coating processes employing waterborne basecoats, such as wherein more than one primer layer is applied, more than one basecoat, or more than one clearcoat, as well as re-coat processed and 2-tone processes, or other complex layer structures.

Waterborne basecoat (WBBC) compositions have been used in the automotive industry as an alternative to solvent-based basecoat compositions in multilayer coating technology processes to provide paint for various types of surfaces. Waterborne basecoat (WBBC) compositions typically have fewer volatile organic compounds (VOCs) than solvent-based paints and are friendly to automotive workers and the environment. Waterborne basecoat compositions generally contain 60% water and approximately 25% total solids. In standard multilayer coating processes, such as low-bake processes, heat is required for the thermal evaporation of water during a pre-heating or flash-off step, which necessitates pre-heating the oven.

As disclosed herein, the method of the present disclosure does not include pre-heating of the uncured basecoat film or a flash-off step with heat as is typically done to drive off water prior to forming the uncured clearcoat film, thereby reducing carbon emissions, energy consumption, labor, and production time, while maintaining desired characteristics of adhesion, surface properties and durability. To achieve this, the method of the present disclosure employs a waterborne basecoat composition to form the uncured basecoat film layer that does not require heating or thermal evaporation of the water before applying the clearcoat composition to form the uncured clearcoat film layer.

The waterborne basecoat composition of the present disclosure is uniquely designed to facilitate room temperature dehydration of the waterborne basecoat without the need for pre-heating ovens, pre-heating, or flash-off with heat steps prior to applying a clearcoat composition onto the waterborne basecoat layer. The waterborne basecoat composition of the present disclosure comprises a film-forming resin comprising hydroxyl functional groups, a crosslinking agent; at least one multifunctional isocyanate comprising between 4-6 isocyanate functional groups, and an aqueous solvent, wherein the waterborne basecoat composition does not require preheating before subsequent application of the clearcoat. The waterborne basecoat composition of the present disclosure achieves the superior advantages of waterborne basecoat compositions over the alternative options without the need for pre-heating lead times as needed for conventional waterborne basecoat applications, waterborne paints, and primers.

The waterborne basecoat composition of the present disclosure utilizes a film-forming resin comprising hydroxyl functional groups. Such resins are selected from acrylic resins, polyester resins, alkyd resins, epoxy resins, and combinations thereof, which contain free hydroxyl groups after synthesis and polymerization of the resin. Suitable examples include but are not limited to hydroxyl-functional acrylic emulsions, hydroxyl-functional polyester dispersions, hydroxyl-alkyl functional alkyd emulsions, hydroxyl-functional epoxy resins, and hybrid resins with hydroxyl-functionality such as acrylic-polyesters, acrylic alkyd resins, epoxy-modified acrylic resins, and epoxy-modified polyester resins. Unlike polyurethane dispersions often used in waterborne coating compositions for multilayer coating processes such as low-bake processes, resins comprising hydroxyl functional groups as disclosed herein contain reactive free hydroxyl groups after polymerization available in the final polymer network.

The film-forming resins comprising reactive hydroxyl functional groups of the present disclosure may also include crosslinking agents such as melamine and melamine-formaldehyde resins. Such crosslinking agents react with the hydroxyl functional groups in the resin forming film during curing, and aide in providing desired hardness, durability, and chemical resistance properties of the basecoat film layer in automotive and industrial coatings. Melamine-formaldehyde crosslinking agents have methylol groups that react with hydroxyl groups in the resin to help form highly crosslinked networks and are particularly suited for use in the waterborne basecoat compositions of the present disclosure. In some examples of the present disclosure, the film-forming resin is an acrylic emulsion in combination with a melamine crosslinking agent which forms a strong crosslinked network leading to a cured firm that provides high gloss, transparency, color retention, chemical resistance, and durability.

The waterborne basecoat (WBBC) compositions of the present disclosure also include multifunctional isocyanates capable of reacting with both water and existing basecoat resins to form a unique crosslinked network without resulting in linear polyurea or chain termination. This enables the basecoat to be sufficiently dehydrated or dried at room temperature, eliminating the pre-heating flash-off step prior to application of the clearcoat while maintaining high-quality paint film properties. The multifunctional isocyanates employed in the waterborne basecoat compositions of the present disclosure preferably have 4- to 6-isocyanate functional groups, which provide strong crosslinking. As a result, the conventional pre-heating and pre-baking steps required for waterborne basecoats can be avoided without compromising the final paint film's physical and aesthetic characteristics

The waterborne basecoat composition of the present disclosure is used to provide a 2-component coating wherein the multifunctional isocyanate is a separate component mixed with the other components of the waterborne basecoat composition prior to application on the substrate, typically by spraying. For example, water, the resins, crosslinking agents, and the additives may be mixed in accordance with standard practices to form the waterborne basecoat composition (WBBC), and the multifunctional isocyanates (MFI) separately added and mixed with the WBBC prior to spraying to form a waterborne basecoat coating composition with multifunctional isocyanates (WBBC-MFI) for forming an uncured waterborne basecoat layer in the multilayer coating process of the present disclosure. In certain examples, the ratio of multifunctional isocyanate to the waterborne basecoat is in the range of 10:1-5:1.

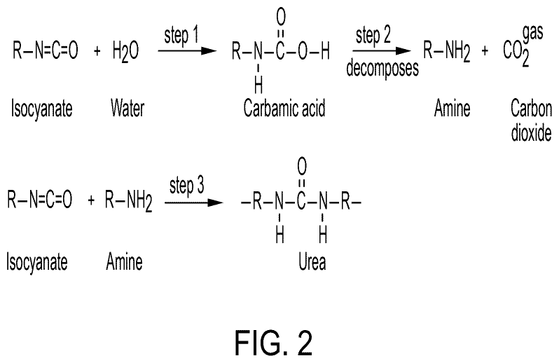

FIG. 2 illustrates the chemical reactions of isocyanate groups in the curing process of waterborne basecoat compositions used in the multilayer coating processes of the present disclosure. In step 1, an isocyanate (R—N═C═O) reacts with water (H₂O) to form carbamic acid. This step consumes water that would otherwise require evaporation by heating. The carbamic acid formed is an unstable carbamic acid intermediate (R—N—C—OH), which spontaneously decomposes in step 2 to yield an amine (R—NH₂) and carbon dioxide gas (CO₂). In step 3, the generated amine reacts with another isocyanate molecule to form a urea linkage (—R—N—C—N—R—), contributing to the crosslinking network essential for film formation, adhesion, and durability at low bake temperatures. Multifunctional isocyanates (with 4-6 isocyanate groups) can also react with hydroxyl (—OH) or amine (—NH₂) groups present in the binder resins. This leads to crosslinking of the polymer network, improving the basecoat's mechanical strength and chemical resistance. Another advantage of employing multifunctional isocyanates having 4- to 6-isocyanate functional groups is that the amine by-product becomes part of the coating structure (urea formation) rather than terminating polymer chains, ensuring a durable, crosslinked film.

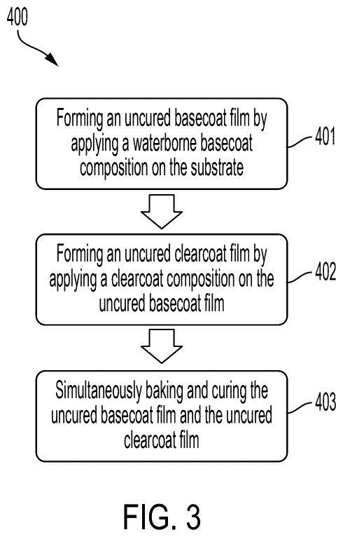

Employing multifunctional isocyanates having 4- to 6-isocyanate functional groups in the waterborne basecoat composition of the present disclosure provides advantages in cross-linking and film formation. However, the carbon dioxide (CO₂) off-gas released when the unstable carbamic acid intermediate (R—N—C—OH) decomposes can cause film defects (e.g., bubbles) if not allowed to escape before the clearcoat is applied. Another example of the method for forming a multilayer coating on a substrate of the present disclosure 400 illustrated in FIG. 3 includes forming an uncured basecoat film by applying a waterborne basecoat composition on the substrate at process block 401; forming an uncured clearcoat film by applying a clearcoat composition on the uncured basecoat film at process block 402; and simultaneously baking and curing the uncured basecoat film and the uncured clearcoat film at process block 403. The method does not include pre-heating or flash-off with heating of the uncured basecoat film prior to forming the uncured clearcoat film. The waterborne basecoat composition of the present disclosure is employed in this method and includes a film-forming resin comprising hydroxyl functional groups, a crosslinking agent, at least one multifunctional isocyanate comprising at between 4-6 isocyanate functional groups, and an aqueous solvent, and does not require preheating prior to application of the clearcoat.

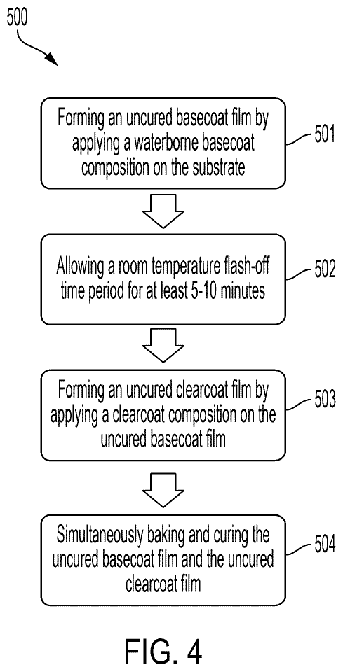

Another example of the method of the present disclosure is illustrated in FIG. 4 and involves forming an uncured basecoat film by applying a waterborne basecoat composition on the substrate at process block 501 and allowing for a room temperature flash-off period without heat for at least 5-10 minutes at process block 502, prior to forming an uncured clearcoat film by applying a clearcoat composition on the uncured basecoat film at process block 503. Formation of the clearcoat layer on the basecoat layer is followed by simultaneously baking and curing the uncured basecoat film and the uncured clearcoat film at process block 504. The method does not include pre-heating or flash-off with heating of the uncured basecoat film prior to forming the uncured clearcoat film.

The waterborne basecoat (WBBC) compositions using 4- or 6-multifunctional isocyanates require 20-40% less material during application. For example, to achieve a 15 μm film of WBBC, it would be necessary to apply about 60 μm of wet paint. However, the 4- or 6-multifunctional isocyanates in the waterborne basecoat (WBBC) compositions of the present disclosure enable reaction with both the main coating resins as well as with the water forming a crosslinked network maintaining strength and integrity such that only 15-20 μm of the waterborne basecoat composition needs to be applied to obtain a WBBC layer having sufficient strength and integrity.

The waterborne basecoat (WBBC) compositions of the present disclosure comprise an aqueous solvent comprising more than 50 wt % water, based on the total weight of the solvent. In certain examples, the solvent for the coating compositions comprises more than 60 weight % water, or more than 70 weight % water, or more than 80 weight % water, or more than 90 weight % water, based on the total weight of the solvent. The solvent for the waterborne coating compositions can also include an organic solvent or solvents mixed with water. Non-limiting examples of organic solvents that can be used include glycols, glycol ether alcohols, alcohols, ketones, glycol diethers, and diesters. Other non-limiting examples of organic solvents include aromatic and aliphatic hydrocarbons. Some examples of the aqueous solvent of the waterborne basecoat composition of the present disclosure have a water content, between 50% and 65% by weight, ensuring low volatile organic compound (VOC) emissions.

The waterborne basecoat (WBBC) coating compositions of the present disclosure may also include pigments, fillers, and additives such as solvents, dispersing agents, rheology modifiers, wetting agents, dispersants, defoamers, pH adjusters, and stabilizers as needed to optimize application performance and coating uniformity. Pigments may be included for color, opacity, and UV protection. Examples of suitable pigments include organic pigments, inorganic pigments, metallic pigments, pearlescent pigments, carbon black, and anti-corrosive pigments. Suitable organic colored pigments include but are not limited to azo chelate-based pigments, insoluble azo-based pigments, condensation azo-based pigments, So-based pigments, benzimidazolone-based pigments, phthalocyanine-based pigments, indigo pigments, perinone-based pigments, perylene-based pigments, dioxane-based pigments, quinacridone-based pigments, isoindolinone-based pigments, and metal complex pigments. Examples of suitable inorganic pigments include but are not limited to chrome yellow, yellowish iron oxide, colcothar, carbon black, and titanium oxide. Suitable examples of metallic pigments include but are not limited to pigments of metal or alloys such as aluminum, copper, zinc, iron, nickel, tin, aluminum oxide, and aluminum flake. Suitable pearlescent or photoluminescent pigments include but are not limited to interference mica, white mica, graphite, and glass flake. Inorganic fillers such as calcium carbonate or silica may be added to adjust the coating's mechanical properties, including hardness and impact resistance. Rheology modifiers may be added to control the basecoat's viscosity and application characteristics.

### Examples

Various aspects of the present disclosure are further illustrated with respect to the following examples. It is to be understood that these examples are provided to illustrate specific embodiments of the present disclosure and should not be construed as limiting the scope of the present disclosure in or to any particular aspect.

### Example 1: Preparation of Waterborne Basecoat Composition (WBBC)

Waterborne basecoat compositions were prepared according to the following procedure. The resins, additives, pigments, and solvents used in the formulation are provided in Table 1.

TABLE 1

| | Resin Parts per | |
|---|---|---|
| Components | hundred (PHR) | Weight % |
| Backbone Resins | | |
| Acrylic emulsions | 5-25 | |
| Polyester dispersions | 0-25 | |
| Polyurethane dispersions | 0-20 | |
| Crosslinker | | |
| Melamine resins | 15-35 | |
| Grind Resins | 5-45 | |
| Other Resins | 0-10 | |
| | TOTAL | 15-25% |
| Additives | | |
| Weathering (e.g. UV absorbers, HALS) | 0-2 | |
| Rheology control agents | 0-2 | |
| Surfactants | 0-2 | |
| Other additives | 0-2 | |
| | TOTAL | 2-5% |
| Pigments | | |
| Organic | 0-10 | |
| Inorganic | 0-20 | |
| Effect | 0-10 | |
| Filler | 0-5 | |
| | TOTAL | 1-20% |
| Solvents | | |
| Water | 55-65 | |
| Organic solvents | 10-15 | |
| | TOTAL | 65-80% |

Water, the resins and the additives were pre-mixed and introduced into a mixing tank under controlled conditions. Separately, pigment dispersions or slurries were prepared. Some pigments were milled with resins and/or dispersing agents to ensure uniform dispersion. Aluminum flakes were passivated and mixed with solvents before incorporation into the formulation.

Once the initial pre-mix was completed, some pigments were added to the mixing tank and blended with the water and resins already present. Additional resins were incrementally introduced and mixed thoroughly to achieve a homogeneous composition. The remaining pigments were then added and dispersed within the basecoat system. Throughout the manufacturing process, pH was carefully controlled to maintain stability.

Upon completion of the mixing process, the batch was evaluated for key properties, including viscosity, non-volatile content, and color. Adjustments were made to ensure that the formulation met the required specifications.

### Example 2: Preparation of Waterborne Basecoat Compositions (WBBC and WBBC-MFI)

Waterborne basecoat (WBBC) compositions and waterborne basecoat compositions with a multifunctional isocyanate (WBBC-WFI) were prepared and compared to control compositions. Table 2 provides sample compositions. 4- and 6-multifunctional isocyanates (Covestro Desmodur N3790 BA and N3580 BA, respectively) were used. For all samples, WBBCs were prepared according to Example 1 for use in forming waterborne basecoats. Multifunctional isocyanates (WBBC-WFI) having 4 isocyanate functional groups (Desmodur N3790 BA) (WBBC-MFI 4) and 6 isocyanate functional groups (Desmodur N3580 BA) (WBBC-MFI 6) were separately added and mixed with the WBBCs of Samples 1-3. The molar ratio for the isocyanate was calculated based on typical WBBC water content.

TABLE 2

| | | | | Filmbuild | | |
|---|---|---|---|---|---|---|
| | WBBC-MFI | Isocyanate | Ratio | Target | Pre-heat | Bake |
| 1. | WBBC-MFI 4 | 4-functional isocyanate | 100:16 | 15-20 μm | — | 140 C. × 18 min keep |
| 2. | WBBC-WFI 4 | 4-functional isocyanate | 100:16 | 15-20 μm | 80 C. × 5 min | 140 C. × 18 min keep |
| 3. | WBBC-MFI 6 | 6-functional isocyanate | 100:11 | 15-20 μm | — | 140 C. × 18 min keep |
| 4. | WBBC | — | — | 15-20 μm | — | 140 C. × 18 min keep |
| 5. | WBBC* | — | — | 15-20 μm | 80 C. × 5 min | 140 C. × 18 min keep |

### Example 3: Preparation of Waterborne Basecoat Compositions (WBBC and WBBC-MFI)

Multilayer film coatings were prepared using the compositions from Example 2 applied to a substrate as the WBBC layer by spraying. Sample 2 and control sample-5 (WBBC*) used a standard process with primer application (WB primer conv (i.e., baked) p/h then bake: flash then bake; WB conv: p/h then bake; WB 3wet: p/h), WBBC application, dehydration bake, clearcoat application, flash, and final bake. Sample 4 underwent the same process as Sample 5, except the WBBC in Sample 4 was not preheated. Samples 1 and 3 were applied similarly to the process set forth for Sample 5 but without the “dehydration bake” step, included WBBCs with multifunctional isocyanates. Table 2 details film thickness, temperature, and duration of pre-bake and final bake steps. Table 3 shows the test results for the samples.

TABLE 3

| | | Isocyanate | |
|---|---|---|---|
| | | 4-functional | 6-functional |
| Basecoat | Physical Properties | Good | Excellent |
| only | Color | Unsatisfactory | Good |
| | Gloss | Good | Excellent |
| Full Film | Adhesion | not tested | Excellent |
| | Chemical Resistance | not tested | Excellent |
| | Appearance | not tested | Excellent |

Judgment Key
Excellent Conforms to expectations, no noticeable flaws
Good Minor deviations, overall quality meets basic standards
Unsatisfactory Significant deviations, major flaws visible, need for improvement

### Example 4: Color and Gloss

The sample coatings were sprayed over a TSOP (The Super Olefin Polymer) bumper substrate for easy removal. Table 4 below shows color and gloss results based only on the basecoat film layer (i.e., no clearcoat), compared to control.

TABLE 4

| | WBBC- | | | Color | Gloss | Gloss | Gloss |
|---|---|---|---|---|---|---|---|
| | MFI | Isocyanate | Ratio | (ΔΕ) | (20°) | (60°) | (85°) |
| 1. | WBBC- | Desmodur | 100:16 | 4.53 | 1.3 | 8.8 | 17.1 |
| | MFI 4 | N3790 BA | | | | | |
| | | (4-functional) | | | | | |
| 2. | WBBC- | Desmodur | 100:16 | 4.37 | 1.2 | 7.9 | 16.7 |
| | MFI 4 | N3790 BA | | | | | |
| | | (4-functional) | | | | | |
| 3. | WBBC- | Desmodur | 100:11 | 2.30 | 2.6 | 17.3 | 31.5 |
| | MFI 6 | N3580 BA | | | | | |
| | | (6-functional) | | | | | |
| 4. | WBBC | — | — | 0.82 | 3.7 | 22.4 | 41.3 |
| 5. | WBBC* | — | — | std | 3.4 | 20.9 | 39.1 |

It can be seen from the results that the 4-functional multifunctional isocyanate affects both the color and gloss of the basecoat. While overall color would likely need to be rematched, the differences in gloss are not considered significant to affect final gloss of the overall film.

### Example 5: Physical Properties

Pieces of the multilayer films were peeled from the bumper substrate for analytical testing. A TA Instruments Q800 Dynamic Mechanical Analyzer® was used to evaluate all physical properties. The conditions matched industry standards. Results are shown in Table 4 below:

TABLE 5

| | | | | Tan | | Crosslink | | | |
|---|---|---|---|---|---|---|---|---|---|
| | | | | delta | | Density | Tensile | Elongation | Young’s |
| | WBBC | Isocyanate | Ratio | peak | Tg | (mol | Strength | at Break | Modulus |
| 1. | WBBC- | Desmodur | 100:16 | 0.44 | 83° C. | 318.5 | 21.38 | 6.22% | 672.0 |
| | MFI 4 | N3790 BA | | | | | | | |
| | | (4-functional) | | | | | | | |
| 2. | WBBC- | Desmodur | 100:16 | 0.43 | 82° C. | 143.2 | 19.98 | 3.84% | 815.1 |
| | MFI 4 | N3790 BA | | | | | | | |
| | | (4-functional) | | | | | | | |
| 3. | WBBC- | Desmodur | 100:11 | 0.34 | 82° C. | 1241.3 | 21.33 | 9.62% | 577.4 |
| | MFI 6 | N3580 BA | | | | | | | |
| | | (6-functional) | | | | | | | |
| 4. | WBBC | — | — | 0.24 | 73º C. | 1835.1 | 19.43 | 4.65% | 784.5 |
| 5. | WBBC* | — | — | 0.23 | 72° C. | 1547.5 | 12.53 | 3.49% | 442.1 |

Tan delta peak height: Samples 1-3 showed results within the range of 0.2-0.75. Performance is typically considered adequate within the range of 0.15-1.0. Higher values suggest more energy absorption, which may indicate chipping performance.

Glass transition (Tg): The samples exhibited Tg values within the range of 70-85° C. Adequate performance is generally regarded as being within the range of 60-90° C. The Tg values of the samples show a difference of 10° C., which is not considered significant since it exceeds the normal use temperature of exterior paint in the field.

Crosslink density: Higher crosslink density generally means better chemical resistance due to a tighter network.

Tensile strength: Higher tensile strength generally means a stronger film.

Elongation at Break: Higher values mean that the film is more flexible, which would be better for chipping performance.

Young's Modulus: Higher values indicate stiffness and brittleness, while lower values mean the material is more flexible and easier to deform,

Conclusion: Both isocyanates increased the Tg and tan delta of the coating. In this particular basecoat formulation, the 6-functional isocyanate exhibited similar performance to basecoat formulations applied with pre-heating. Other basecoat formulations are envisioned in which the 4-functional isocyanate shows similar performance.

### Example 6: Coating Samples

Samples were prepared for characterization of complete film properties utilizing a WBBC with a 6-functional isocyanate. Table 6 details the composition of the WBBC, clearcoat, temperature, and duration of pre-bake and final bake steps.

TABLE 6

| | Primer | WBBC | Isocyanate | Ratio | Clearcoat | Pre-heat | Bake |
|---|---|---|---|---|---|---|---|
| 1. | Standard | WBBC- | Desmodur | 100:11 | Standard | — | 140 C × |
| | | MFI 6 | N3580 BA | | | | 18 min |
| | | | (6-functional) | | | | keep |
| 5. | Standard | WBBC* | — | — | Standard | 80 C × | 140 C × |
| | | | | | | 5 min | 18 min |
| | | | | | | | keep |

### Example 7: Adhesion

Samples prepared according to Example 6 were tested for initial adhesion and water resistance (10 days×40° C. water soak). The results are shown in Table 7.

TABLE 7

| | | | | | | | Water |
|---|---|---|---|---|---|---|---|
| | Primer | WBBC | Isocyanate | Ratio | Clearcoat | Adhesion | Resistance |
| 1. | Standard | WBBC- | Desmodur | 100:11 | Standard | 0/100 | No peeling |
| | | MFI 6 | N3580 BA | | | | |
| | | | (6-functional) | | | | |
| 5. | Standard | WBBC* | — | — | Standard | 0/100 | No peeling |

The results show that Sample 1 using WBBC-MFI 6 of the present disclosure performed similarly to the control Sample 5.

### Example 8: Chemical Resistance

Samples from Example 6 were tested for chemical resistance. The results are shown in Table 8.

TABLE 8

| | | | | | | | | | Volatile |
|---|---|---|---|---|---|---|---|---|---|
| | Primer | WBBC | Isocyanate | Ratio | Clearcoat | Water Spot | Alkali Spot | Acid Spot | Solvent |
| 1 | Standard | WBBC- | Desmodur | 100:11 | Standard | AE = 0.32 | AE = 0.42 | AE = 0.08 | AE = 0.14 |
| | | MFI 6 | N3580 BA | | | AG = 3 | AG = 3 | AG = 1 | AG = 0 |
| | | | (6-functional) | | | | | | |
| 5. | Standard | WBBC* | — | — | Standard | AE = 0.22 | AE = 0.31 | AE = 0.28 | AE = 0.07 |
| | | | | | | AG = 1 | AG = 1 | AG = 1 | AG = 1 |

The results show that Sample 1 using the WBBC-MFI 6 of the present disclosure performed similarly to control Sample 5.

### Example 9. Appearance

Samples from Example 7 were tested for the appearance of the significant popping (i.e., foaming or bubbling due to CO₂ off-gassing) at different flash-off time at room temperature (i.e., room temperature flash). The results are shown in Table 9.

TABLE 9

| | Primer | WBBC | Isocyanate | Ratio | Clearcoat | Flash | Bake | Popping |
|---|---|---|---|---|---|---|---|---|
| 1A | Standard | WBBC- | Desmodur | 100:11 | Standard | — | 140 C × | Significant |
| | | MFI 6 | N3580 BA | | | | 18 min | |
| | | | (6-functional) | | | | keep | |
| 1B | Standard | WBBC- | Desmodur | 100:11 | Standard | 3 min × RT | 140 C × | Significant |
| | | MFI 6 | N3580 BA | | | | 18 min | |
| | | | (6-functional) | | | | keep | |
| 1C | Standard | WBBC- | Desmodur | 100:11 | Standard | 5 min × RT | 140 C × | Moderate |
| | | MFI 6 | N3580 BA | | | | 18 min | |
| | | | (6-functional) | | | | keep | |
| 1D | Standard | WBBC- | Desmodur | 100:11 | Standard | 10 min × RT | 140 C × | None |
| | | MFI 6 | N3580 BA | | | | 18 min | |
| | | | (6-functional) | | | | keep | |

The results show that after 5 minutes of flash-off time with no heat, there was moderate popping (Sample 1C) and after 10 minutes of flash-off time without heat (Sample 1D), there was no significant popping or bubbles in the coating.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple embodiments having stated features is not intended to exclude other embodiments having additional features, or other embodiments incorporating different combinations of the stated features.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an embodiment can or may comprise certain elements or features does not exclude other embodiments of the present technology that do not contain those elements or features.

As used herein, the term “about”, in the context of concentrations of components of the formulations, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with an embodiment or particular system is included in at least one embodiment or aspect. The appearances of the phrase “in one aspect” (or variations thereof) are not necessarily referring to the same aspect or embodiment. It should be also understood that the various method steps discussed herein do not have to be carried out in the same order as depicted, and not each method step is required in each aspect or embodiment.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations should not be regarded as a departure from the disclosure, and all such modifications are intended to be included within the scope of the disclosure.

What is claimed is:

1. A waterborne basecoat composition, comprising:
a film-forming resin comprising hydroxyl functional groups;
a crosslinking-agent;
at least one multifunctional isocyanate comprising between 4-6 isocyanate functional groups; and
an aqueous solvent,
wherein the waterborne basecoat composition does not require preheating when employed in a multilayer coating process.

2. The composition according to claim 1, wherein the crosslinking agent is selected from melamine and melamine-formaldehyde resins.

3. The composition according to claim 1, wherein the at least one multifunctional isocyanate comprises 4 isocyanate functional groups.

4. The composition according to claim 1, wherein the at least one multifunctional isocyanate comprises 6 isocyanate functional groups.

5. The composition according to claim 1, further comprising at least one pigment selected from organic pigments, inorganic pigments, metallic pigments, pearlescent pigments, carbon black, and anti-corrosive pigments.

6. The composition according to claim 5, wherein the at least one pigment is a metallic pigment.

7. The composition according to claim 6, wherein the metallic pigment comprises aluminum flakes.

8. The composition according to claim 1, further comprising additives selected from solvents, dispersing agents, rheology modifiers, wetting agents, defoamers, pH adjusters, and stabilizers.

9. The composition according to claim 1, wherein the composition is employed to form a paint film.

10. A substrate at least partially coated with the composition according to claim 1.

11. A method for forming a multilayer coating on a substrate comprising:
forming an uncured basecoat film by applying a waterborne basecoat composition on the substrate;
forming an uncured clearcoat film by applying a clearcoat composition on the uncured basecoat film; and
simultaneously baking and curing the uncured basecoat film and the uncured clearcoat film,
wherein the method does not include pre-heating the uncured basecoat film prior to forming the uncured clearcoat film,
wherein the waterborne basecoat composition comprises a film-forming resin comprising hydroxyl functional groups, a crosslinking agent, at least one multifunctional isocyanate comprising at between 4-6 isocyanate functional groups, and an aqueous solvent, and wherein the waterborne basecoat composition does not require preheating.

12. The method according to claim 11, after applying the waterborne basecoat composition and prior to applying the clearcoat composition, further comprising a room temperature flash-off time period for at least 5-10 minutes.

13. The method according to claim 11, further comprising, prior to applying the waterborne basecoat composition on the substrate, applying a primer composition on the substrate followed by baking to form a primer layer.

14. The method according to claim 11, wherein baking is at a temperature range of 50-160° C.

15. The method according to claim 11, wherein the crosslinking agent is selected from melamine and melamine-formaldehyde resins.

16. The method according to claim 11, wherein the at least one multifunctional isocyanate comprises 4 isocyanate functional groups.

17. The method according to claim 11, wherein the at least one multifunctional isocyanate comprises 6 functional groups.

18. The method according to claim 11, wherein the multilayer coating is a paint.

19. The method according to claim 11, wherein the substrate is selected from metal, plastic, composite materials, glass, ceramics, foams, and textiles.

20. The method according to claim 11, wherein an amount of the basecoat applied is 2-4 times less than typically applied to achieve a basecoat layer having a thickness of 10-20 micron layer.
